(19) United States
(12) Patent Application Publication
(10) Pub. No.: US 2026/0044719 A1
(43) Pub. Date: Feb. 12, 2026

(54) QUANTIZATION METHODS FOR GNB-DRIVEN MULTI-VENDOR SEQUENTIAL TRAINING

(71) Applicant: QUALCOMM Incorporated, San Diego, CA (US)

(72) Inventors: Abdelrahman Mohamed Ahmed Mohamed IBRAHIM, San Diego, CA (US); June NAMGOONG, San Diego, CA (US); Taesang YOO, San Diego, CA (US); Jay Kumar SUNDARARAJAN, San Diego, CA (US); Chenxi HAO, Beijing (CN); Naga BHUSHAN, San Diego, CA (US)

(21) Appl. No.: 19/101,220

(22) PCT Filed: Sep. 30, 2022
(86) PCT No.: PCT/CN2022/123068

§ 371 Date: Feb. 4, 2025

(51) Int. Cl. G06N 3/0495; G06N 3/0455; G06N 3/08

(52) U.S. Cl. CPC G06N 3/0495; G06N 3/0455; G06N 3/08

(57) ABSTRACT

Method and apparatus for quantization of base station driven multi-vendor sequential training. The apparatus generates an encoder output by inputting an input CSI to a reference encoder. The apparatus quantizes the encoder output by inputting the encoder output to a quantizer to generate a quantizer output. The apparatus trains a decoder of the network entity based at least on the quantizer output to generate a training dataset. The apparatus outputs a training dataset indication comprising the training dataset to a UE, the training dataset indication comprising at least the input CSI. The apparatus communicates with the UE using the trained decoder.

### TECHNICAL FIELD

The present disclosure relates generally to communication systems, and more particularly, to a configuration for quantization methods for gNB-driven multi-vendor sequential training.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a device at a network entity. The device may be a processor and/or a modem at a network entity or the network entity itself. The apparatus generates an encoder output by inputting an input channel state information (CSI) to a reference encoder. The apparatus quantizes the encoder output by inputting the encoder output to a quantizer to generate a quantizer output. The apparatus trains a decoder of the network entity based at least on the quantizer output to generate a training dataset. The apparatus outputs a training dataset indication comprising the training dataset to a user equipment (UE), the training dataset indication comprising at least the input CSI. The apparatus communicates with the UE using the trained decoder.

In an aspect of the disclosure, a method, a computer-readable medium, and an apparatus are provided. The apparatus may be a device at a UE. The device may be a processor and/or a modem at a UE or the UE itself. The apparatus receives, from a network entity, a training dataset indication comprising a training dataset to train an encoder of the UE, the training dataset comprising at least an input channel state information (CSI). The apparatus inputs the input CSI to the encoder of the UE to generate an encoder output. The apparatus trains the encoder of the UE based on the training dataset and the encoder output. The apparatus communicates with the network entity using the trained encoder.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 illustrates an example of a cross-node machine learning neural network.

FIG. 5 illustrates an example of UE-base station pairs.

FIGS. 6A and 6B illustrate an example of a one-sided concurrent training.

FIGS. 7A and 7B illustrate an example of base station driven sequential training.

FIGS. 8A and 8B illustrate an example of base station driven sequential training.

FIGS. 9A and 9B illustrate an example of vector quantization.

FIG. 10 illustrates an example of vector quantization.

FIGS. 11A and 11B illustrate an example of quantization training at a base station.

FIGS. 12A and 12B illustrate an example of quantization training at a base station.

FIG. 13 illustrates an example of quantization training at a base station.

FIG. 14 illustrates an example of quantization training at a UE.

FIG. 15 is a call flow diagram of signaling between a UE and a base station.

FIG. 16 is a flowchart of a method of wireless communication.

FIG. 17 is a flowchart of a method of wireless communication.

FIG. 18 is a diagram illustrating an example of a hardware implementation for an example network entity.

FIG. 19 is a flowchart of a method of wireless communication.

FIG. 20 is a flowchart of a method of wireless communication.

FIG. 21 is a diagram illustrating an example of a hardware implementation for an example apparatus and/or network entity.

### DETAILED DESCRIPTION

In cross-node machine learning, a neural network may be split into two portions, where a first portion includes an encoder of a UE, and a second portion includes a decoder of a base station. The encoder output of the UE is transmitted to the base station as an input to the decoder. To evaluate the machine learning base CSI compression use cases, one or more different types of quantization or dequantization methods may be used, such as but not limited to vector quantization, scalar quantization, or the like. In CSI compression using two-sided model use cases, multiple machine learning model trainings may be utilized. In some instances, multi-node (e.g., two-sided) channel state feedback compression may be useful. However, training two-sided models across multiple vendors may be an issue.

Aspects presented herein provide a configuration for quantization methods for base station driven multi-vendor sequential training. The disclosure may allow for training a shared base station decoder that may operate with multiple UE encoders.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

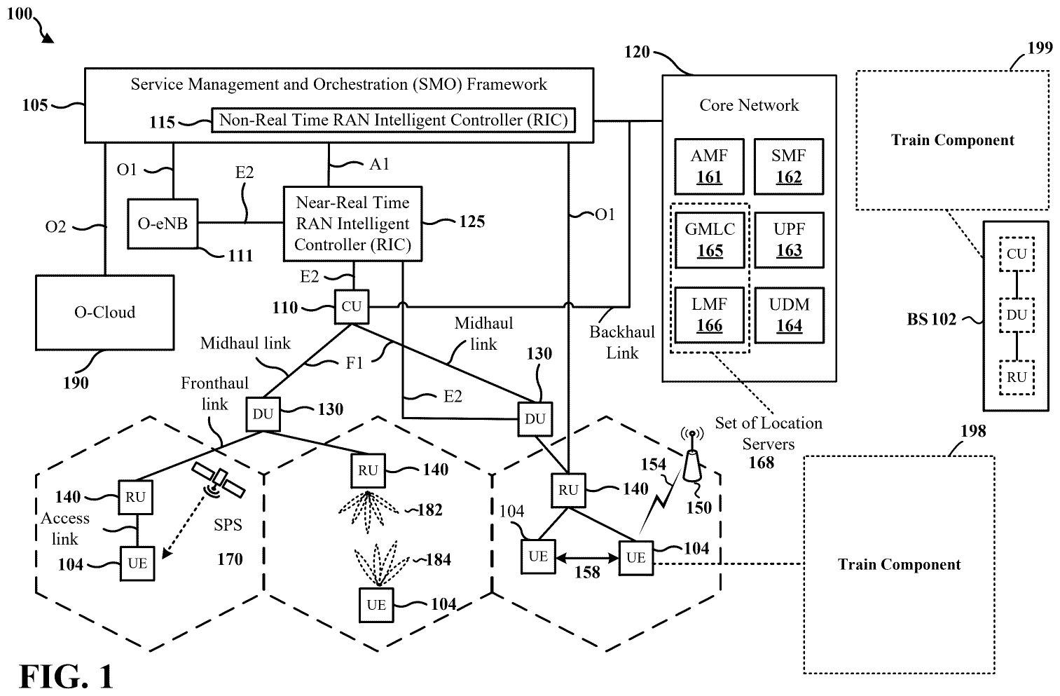

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an Al interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as Al policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may comprise a train component 198 configured to receive, from a network entity, a training dataset indication comprising a training dataset to train an encoder of the UE, the training dataset comprising at least an input CSI; input the input CSI to the encoder of the UE to generate an encoder output; train the encoder of the UE based on the training dataset and the encoder output; and communicate with the network entity using the trained encoder.

Referring again to FIG. 1, in certain aspects, the base station 102 may comprise a train component 199 configured to generate an encoder output by inputting an input CSI to a reference encoder; quantize the encoder output by inputting the encoder output to a quantizer to generate a quantizer output; train a decoder of the network entity based at least on the quantizer output to generate a training dataset; output a training dataset indication comprising the training dataset to a UE, the training dataset indication comprising at least the input CSI; and communicate with the UE using the trained decoder.

Although the following description may be focused on 5G NR, the concepts described herein may be applicable to other similar areas, such as LTE, LTE-A, CDMA, GSM, and other wireless technologies.

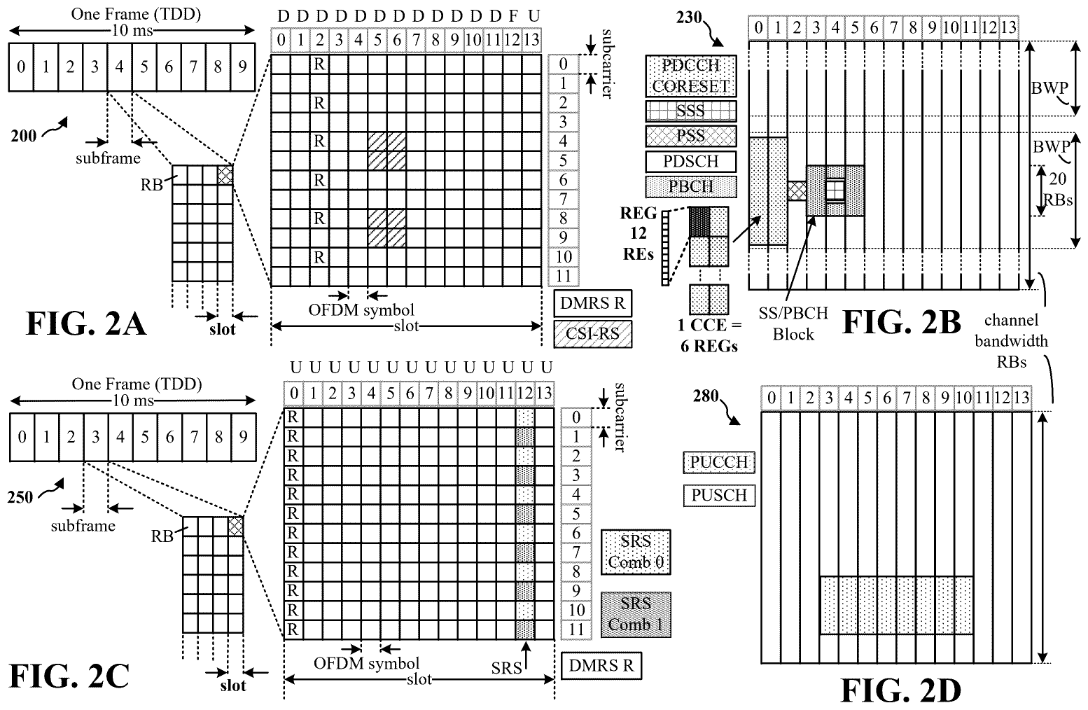

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μb * 15} kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

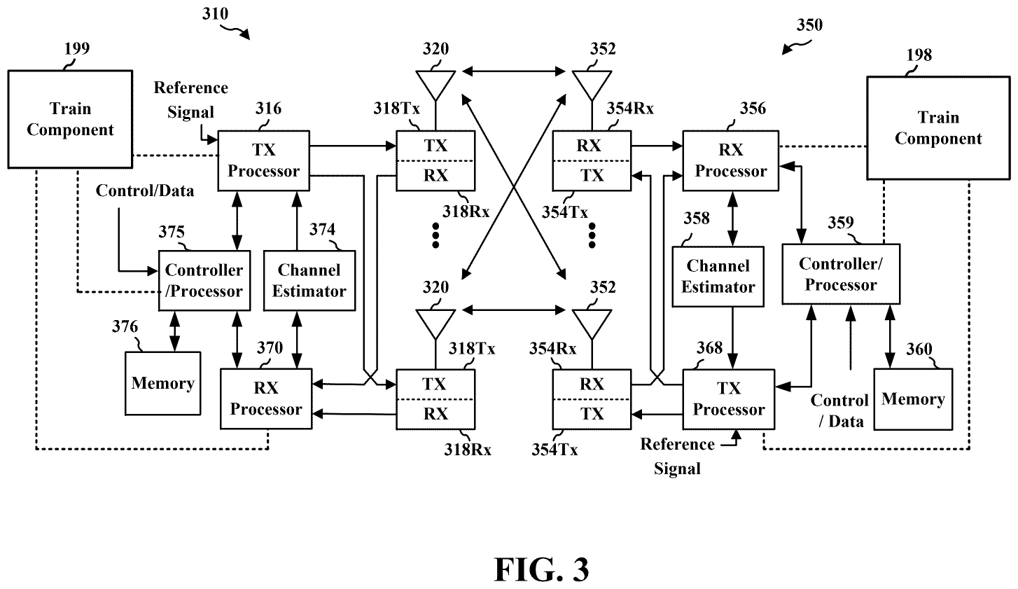

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the train component 198 of FIG. 1.

At least one of the TX processor 316, the RX processor 370, and the controller/processor 375 may be configured to perform aspects in connection with the train component 199 of FIG. 1.

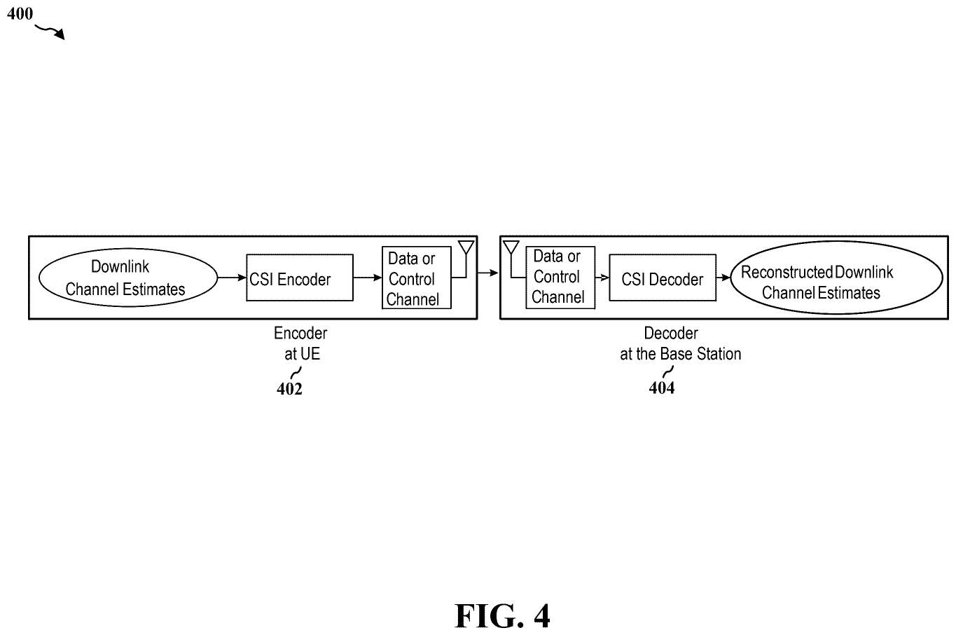

In cross-node machine learning, a neural network may be split into two portions, where a first portion includes an encoder of a UE, and a second portion includes a decoder of a base station. The encoder output of the UE is transmitted to the base station as an input to the decoder. For example, as shown in diagram 400 of FIG. 4, the encoder 402 at a UE may output a compressed channel state feedback (CSF) or other data signal, which is received as input at the decoder 404 of the base station. The decoder at the base station may output a reconstructed CSF or other data signal, such as but not limited to precoding vectors.

In multi-vendor training, each vendor (e.g., UE vendor, base station vendor) may be associated with a corresponding server that participates in offline training. The UE vendor server(s) communicate with the base station vendor server(s) during the training using server-to-server connections.

To evaluate the machine learning base CSI compression use cases, one or more different types of quantization or dequantization methods may be used, such as but not limited to vector quantization, scalar quantization, or the like. In CSI compression using two-sided model use cases, multiple machine learning model trainings may be utilized. In some instances, joint training of the two-sided model at a single side/entity (e.g., UE-sided or network-sided) may be utilized. In some instances, joint training of the two-sided model at a network side and a UE side, respectively, may be utilized. In yet some instances, separate training at a network side and a UE side, where the UE side CSI generation part and the network side CSI reconstruction part are trained by the UE side and the network side, respectively, may be utilized. Joint training may refer to the generation model and reconstruction model being trained in the same loop for forward propagation and backward propagation. Joint training may be done both at a single node or across multiple nodes (e.g., through gradient exchange between nodes). Separate training may include sequential training starting with the UE side training, or sequential training starting with the network side training, or parallel training at the UE and the network.

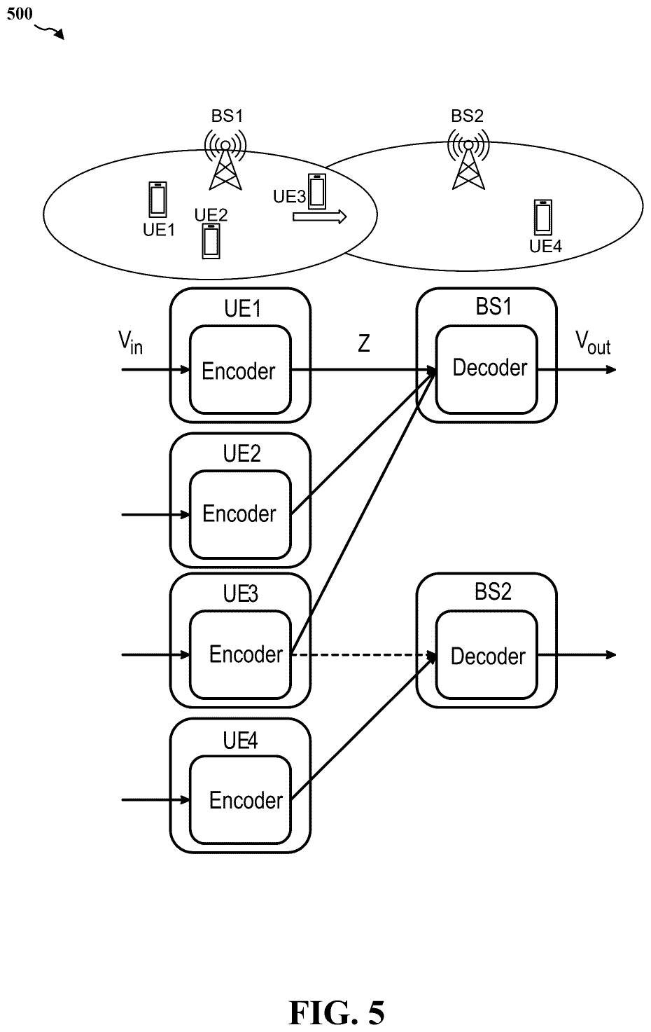

FIG. 5 illustrates an example of UE-base station pairs. For example, the diagram 500 of FIG. 5 includes a first base station BS1 and a second base station BS2 providing a respective cell, and multiple UEs (e.g., UE1, UE2, UE3, UE4) within the coverage region of BS1 or BS2. In instances without multi-vendor training, each UE-base station pair would need to utilize different encoder-decoder pairs. Multi-vendor training eliminates the need to utilize different encoder-decoder pairs for each UE-base station pairing. For example, in instances of multi-UE vendors with one base station vendor, a common base station decoder may be trained to work with multiple UE encoders. As such, the base station does not need to maintain a separate decoder model for each UE in its cell. In instances of a single-UE vendor with multi-base station vendors, a common UE encoder may be trained to work with multiple base station decoders. In such instances, the UE does not need to maintain a separate encoder model for each base station (e.g., UE moving to a new cell). In instances of multi-UE vendors with multi-base station vendors, the UE encoder may be trained to work with multiple base station decoders, while the base station decoder may be trained to work with multiple UE encoder. With reference to FIG. 4, the respective encoders of UE1 and UE2 may be trained to work with the decoder of BS1, while the encoder of UE4 may be trained to work with the decoder of BS2. However, UE3 may be at a cell edge and between BS1 and BS2, such that the encoder of UE3 may be trained to work with the decoder of either BS1 or BS2.

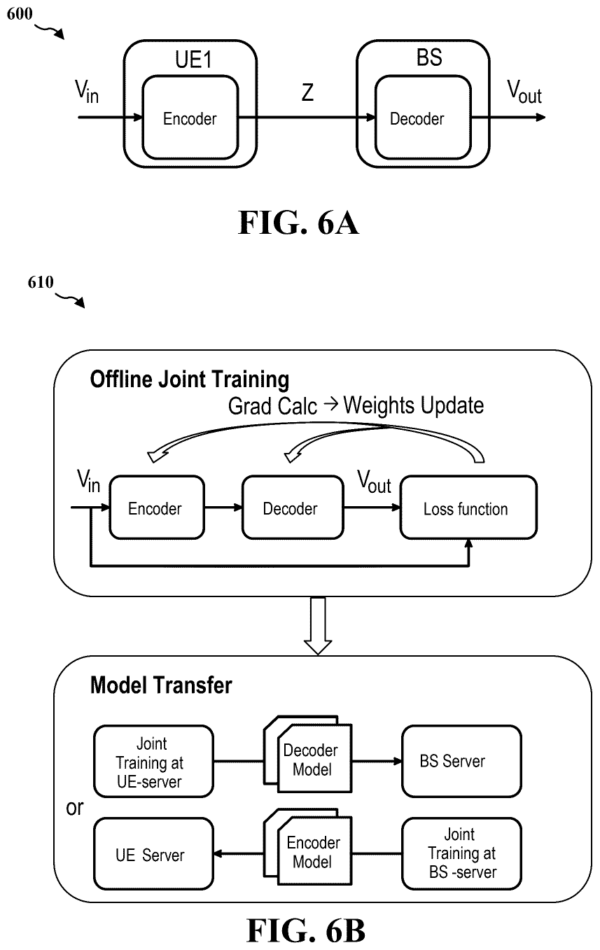

FIGS. 6A and 6B illustrate an example of one-sided concurrent training. In one-sided concurrent training (e.g., offline), both the encoder and the decoder may be trained jointly, such that the model weights of the encoder and decoder can be both optimized jointly. In offline concurrent training, models may be trained offline and may be provided to either the base station or the UE. However, one-sided concurrent training may allow for the trained models to be exposed to the base station or the UE. Joint training may occur at the UE server or the base station server. For example, a UE vendor may train both the encoder and decoder models using its own dataset and may share the trained decoder model with the base station vendor, that is a different vendor than that of the UE vendor. The decoder shared with the other vendor may reveal or provide relevant information related to implementation details of the UE vendor's modem. This information may be revealed due in part to symmetry that typically exists between the encoder and the decoder. As such, the trained encoder and decoder may be a trade secret or include proprietary information that a vendor may not want to reveal to a competitor.

With reference to diagram 600 of FIG. 6A, Vin is received by the encoder of UEL and is compressed and the output of the encoder Z is transmitted to the decoder of the BS, where the BS decodes Z to reconstruct the Vin as Vout. Diagram 610 of FIG. 6B, provides an example of offline training and model transfer. The Vin and Vout may be received by a loss function that determines the difference between the original input Vin of the encoder and the reconstructed version of the original input Vout of the decoder. The gradient may be calculated based on the loss function and the weights of the encoder or decoder may be updated to train the encoder or decoder. The trained encoder or decoder models may be provided to the BS server and/or the UE server.

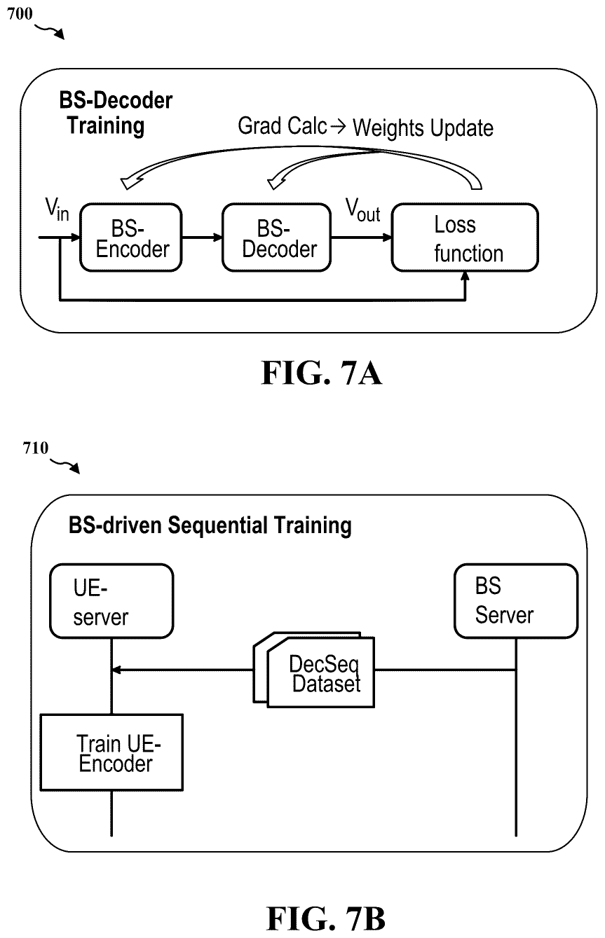

FIGS. 7A and 7B illustrate an example of BS driven sequential training. In sequential training, instead of revealing the neural network or model architecture as in one-sided concurrent training, sequential training allows for the UE or base station to keep the trained models private. In base station driven sequential training, the base station decoder may be trained first at the base station server with an encoder selected by the base station, as shown in diagram 700 of FIG. 7A. The UE encoder may be trained based on a dataset shared by the base station, for example, as shown in diagram 710 of FIG. 7B. The dataset shared with the UE may include the original input Vin and the output of the encoder Z.

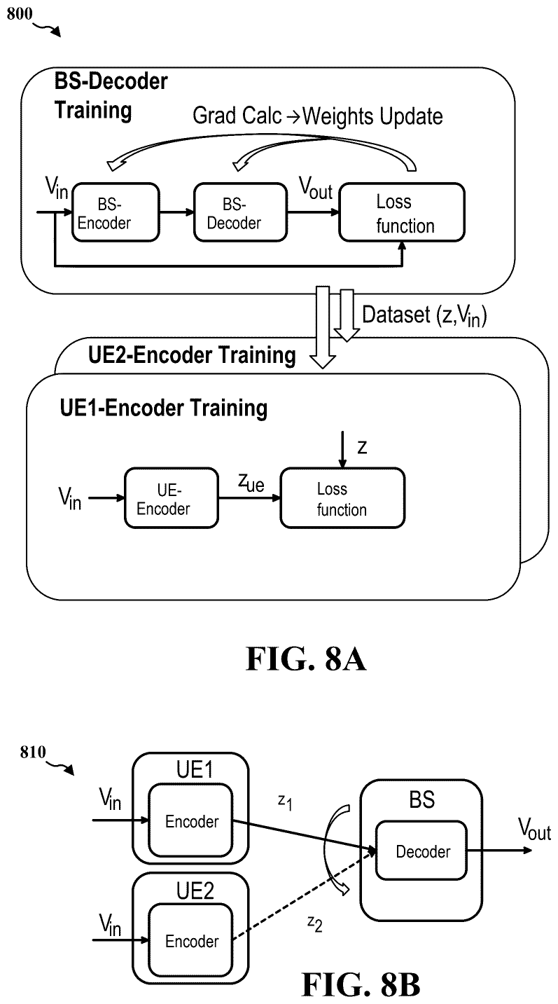

FIGS. 8A and 8B illustrate an example of BS driven sequential training. In the example of FIGS. 8A and 8B, multiple UE encoders may be trained based on the trained base station decoder. For example, in the diagram 800 of FIG. 8A, the base station decoder may be trained in a manner similar as discussed herein with regards to FIG. 7A. The base station may then share the dataset to each of the UEs (e.g., UE1, UE1) so that the respective UE encoders may be trained based on the dataset shared by the base station. In some instances, the original input Vin used as input at the base station encoder may comprise a precoder vector V. The base station server may train the base station decoder and generates a sequential training dataset (e.g., Z, Vin) which is shared with the UE server. Each UE server trains the respective UE encoder based on the sequential training dataset, as shown for example in diagram 810 of FIG. 8B. In some instances, training the UE encoder may be achieved by minimizing a loss between Z (e.g., output of the base station encoder) with Zue which is the output of the UE encoder, such that MSE(Z, Zue) where MSE=E[||z−zᵤₑ||²].

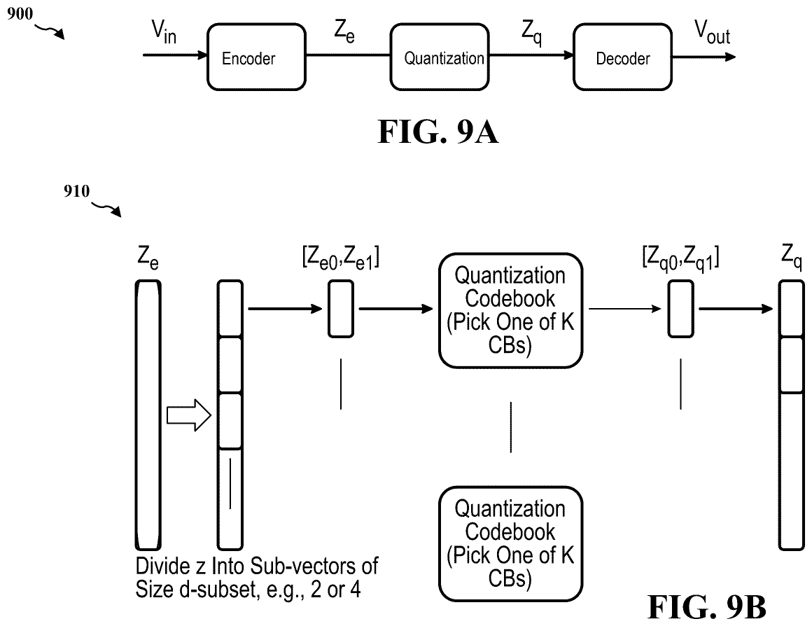

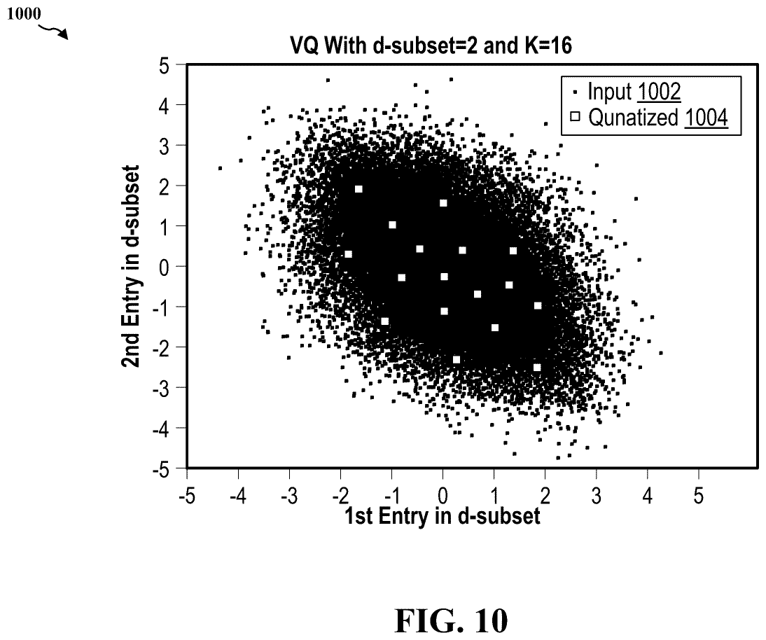

FIGS. 9A, 9B, and 10 provide an example of vector quantization. In vector quantization, each input vector may be quantized and mapped to one of the vectors in a quantization codebook. In some instances, quantization codebook may comprise vectors of size 2 or 4 where each entry may be represented by 2 bits. However, in other instances, the quantization codebook may comprise vectors of different sizes and is not limited to vector sizes of 2 or 4, and may comprise vector sizes other than 2 or 4. In addition, the entries may be represented by any size bits and the disclosure is not intended to be limited to entries being represented by 2 bits.

With reference to diagram 900 of FIG. 9A, the input Vin may be inputted into the encoder, which produces an encoder output Ze. The encoder output Ze may be quantized to produce a quantized output Zq. The quantized output Zq may be processed by the decoder in an effort to reconstruct the Vin, where the decoder output is Vout. With reference to diagram 910 of FIG. 9B, to perform the quantization, the quantizer may receive the encoder output Ze and divide Ze into sub-vectors of size d-subset (e.g., 2 or 4). A sub-vector (e.g., Zeo, Ze1) is quantized based on a quantization codebook to produce a quantized sub-vector (e.g., Zq0, Zq1), where the quantized sub-vector is mapped to one of the vectors in the codebook, for example, as shown in diagram 1000 of FIG. 10. To perform the mapping based on the codebook, the quantizer maps the values of the quantized sub-vector to two values of the codebook (e.g., one of K values of the codebook). For example, with reference to FIG. 10, the input 1002 is the input to the quantizer, where the quantizer maps the inputs to the closest quantized value 1004 of the codebook. The quantized sub-vectors are then merged to form the quantized output Zq.

In some instances, multi-node (e.g., two-sided) channel state feedback compression may be useful. However, training two-sided models across multiple vendors may be an issue.

Aspects presented herein provide a configuration for quantization methods for base station driven multi-vendor sequential training. The disclosure may allow for training a shared base station decoder that may operate with multiple UE encoders. In some instances, a UE may quantize a latent vector prior to transmission to a base station in order to convey the latent vector only using a finite number of bits. In some instances, scalar quantization or vector quantization may be applied to the latent vectors. Quantization may be achieved by using codebooks that comprise a finite number of scalars or vectors. The codebooks may be learned together with the neural network for encoders and decoders in an end-to-end learning. At least one advantage of the disclosure is that multiple quantization schemes may be utilized for multi-vendor separate training for multi-node channel state feedback. In some aspects, vector quantization methods may be used for base station driven sequential training in a multi-vendor configuration.

In some aspects, a quantizer may be trained at the base station server. The base station server may be a component of the base station or may be a component that is external to the base station. As used herein, base station and base station server may be interchangeable, such that training operations may be performed at the base station, the base station server, or a combination thereof. In addition, as further used herein, a UE and a UE server may be interchangeable, such that training operations may be performed at the UE, the UE server, or a combination thereof. The UE server may be a component of the UE or may be a component that is external to the UE.

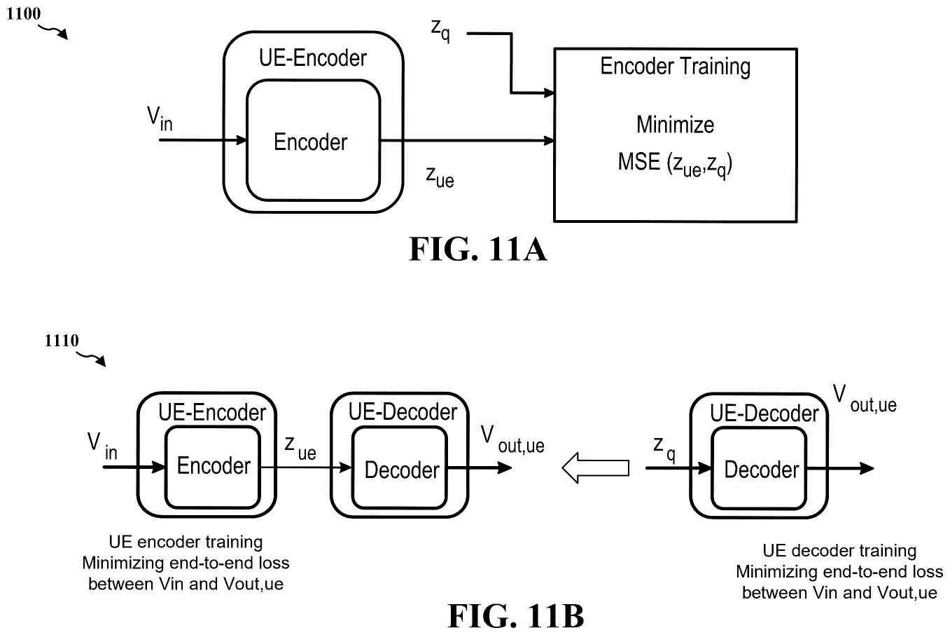

The quantization codebooks (e.g., vector codebook or scalar codebook) may be determined at the base station as part of training of a shared decoder. In some aspects, the base station may share a training dataset with the UE. The training dataset may comprise an output of the base station quantizer Zq and the initial input Vin. In some aspects, Vin may comprise an input CSI. The UE trains the UE encoder by minimizing the loss between Zq and the UE encoder output Zue. If the loss between Zq and Zue is within a threshold, the quantization error may be small as in inference stage Zue may be mapped to Zq, for example, as shown in diagram 1100 of FIG. 11A.

In some aspects, the UE may train the UE encoder by minimizing an end-to-end loss based on a decoder trained by the UE, as shown in diagram 1110 of FIG. 11B. The decoder trained by the UE may be based on Zq and Vin or a reference decoder shared by the base station.

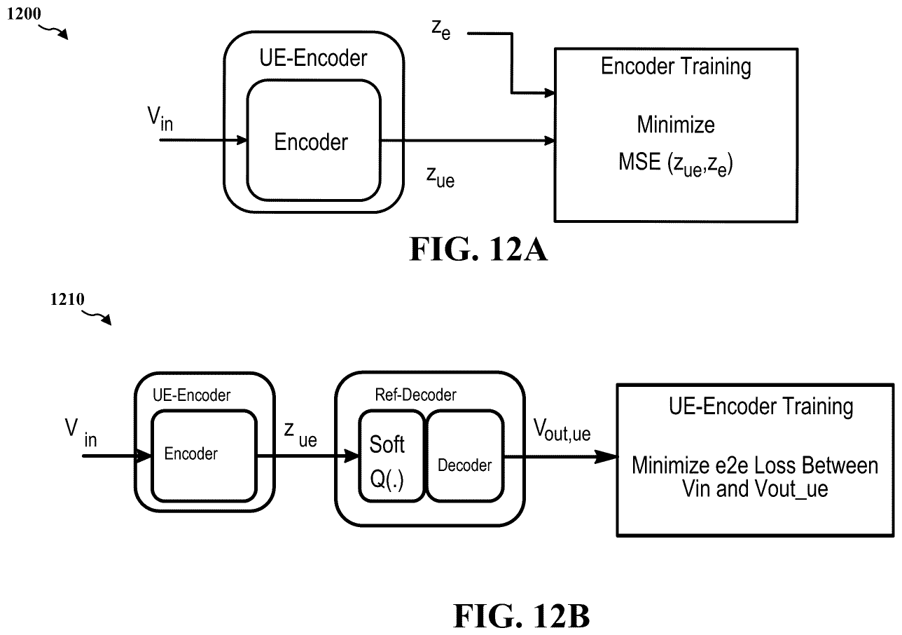

In some aspects, the base station may share a training dataset comprising the initial input Vin and an input to a quantizer Ze, where Ze may also comprise the output of the encoder used by the base station. The UE may train the UE encoder using the Ze and Vin, where the UE encoder produces a UE encoder output Zue, such that the UE trains the UE encoder by minimizing the loss between Ze and Zue, for example, as shown in diagram 1200 of FIG. 12A.

In some aspects, the UE may train the UE encoder by minimizing an end-to-end loss based on a reference decoder provided by the base station. The reference decoder input layers may be configured to mimic a quantization impact (e.g., soft quantization of the sub-vectors). The UE may train the UE encoder by minimizing the end-to-end loss between Vin and an output of the reference decoder Vout,ue. For example, with reference to diagram 1210 of FIG. 12B, the UE may receive Vin and the reference decoder. Vin is inputted into the UE encoder and produces a UE encoder output Zue, which is then inputted into the reference decoder provided by the base station. The reference decoder may comprise a soft quantization (e.g., Soft Q(·)) that mimics the quantization impact, where the reference decoder generates a reference decoder output Vout,uc.

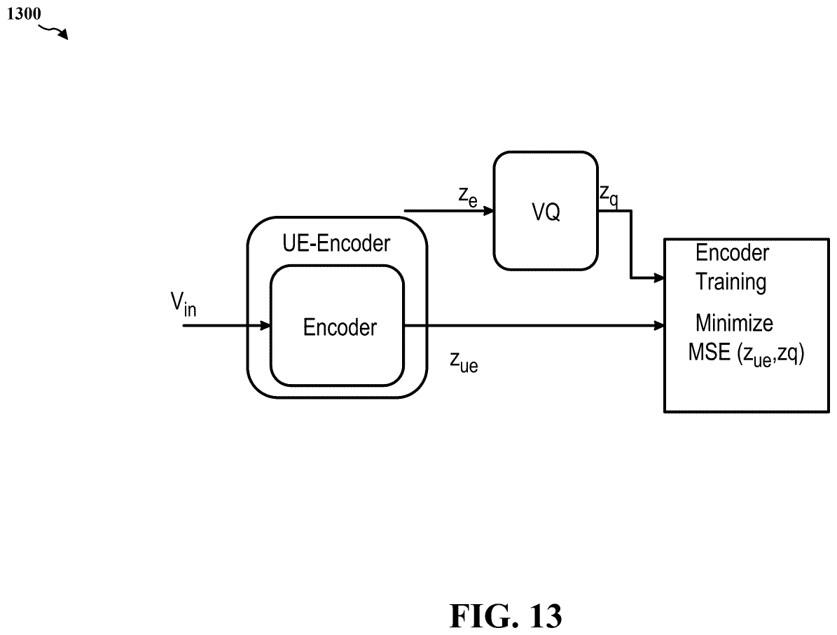

In some aspects, the base station may share a training dataset comprising Ze, Vin and a quantization codebook (e.g., vector quantization codebook, scalar quantization codebook). The base station may share the training dataset comprising Ze, Vin and the quantization codebook with the UE. The training dataset comprising Ze, Vin, and the quantization codebook may be equivalent to the base station sharing a training dataset comprising Ze, Zq, and Vin. The UE may generate Zq from Ze using the quantization codebook. The UE may train the UE encoder by minimizing the loss between Zq and the encoder input (e.g., Vin). With reference to diagram 1300 of FIG. 13, the UE may derive Zq based on the vector quantization codebook (e.g., VQ) and Ze, such that the Ze is mapped based on the vector quantization codebook VQ to generate the quantized output Zq. The UE encoder receives as input the Vin and generates a UE encoder output Zue, where the UE trains the UE encoder by minimizing the loss between Zq and the UE encoder output Zue. In some aspects, the UE may train the UE encoder by minimizing an end-to-end loss based on a decoder trained by the UE based on Zq and Vin, or a reference decoder shared by the base station.

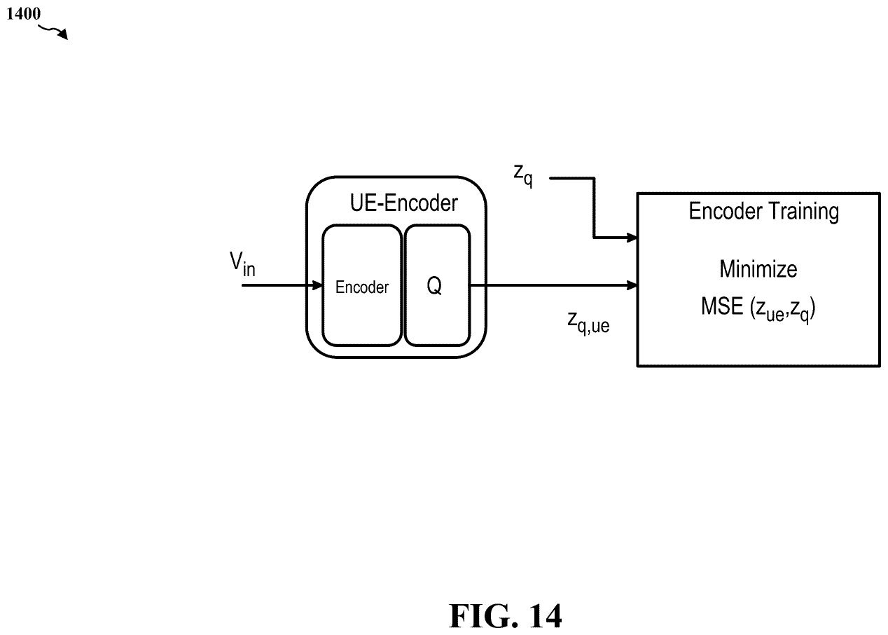

In some aspects, quantization codebooks (e.g., vector quantization codebook, scalar quantization codebook) may be determined by the UE as part of a training process of the encoder. For example, the base station may provide to the UE a training dataset comprising a quantized output at the base station Zq and the initial input Vin. The UE may train the UE encoder and a UE quantizer to match Zq from the training dataset. For example, with reference to diagram 1400 of FIG. 14, the UE encoder receives Vin as input, from the training dataset, and is inputted into the UE encoder. The UE encoder may comprise a vector quantizer VQ, such that the UE encoder and VQ generate a UE encoder output Zq,ue. The UE trains the encoder and the vector quantizer VQ by minimizing the loss between Zq and Zq,ue. In some aspects, the base station may provide the UE with a training dataset comprising a base station encoder output Ze, an initial input Vin and a quantizer codebook (e.g., vector quantization codebook, scalar quantization codebook). The quantizer codebook may be retrained as part of the encoder training. The loss function may be comprised of two terms, loss (Zq, Zq,ue)+alpha*loss (Zue, Zq,ue).

In some instances, the quantization codebook may be known by the UE and the base station. Quantization may be trained at the UE or the base station. After training, the quantization codebooks may be shared with the other vendor entity (e.g., server). In some aspects, the training dataset may comprise a sequential training dataset (e.g., (Ze, Vin), (Zq, Vin), or (Ze, Zq, Vin). In some aspects, the training dataset may comprise the quantization codebook. In some aspects, the quantization may be trained at the base station with a shared decoder. In some aspects, the quantization may be trained at the UE with an encoder. In some aspects, the quantization may be trained at the base station and retrained or refined at the UE.

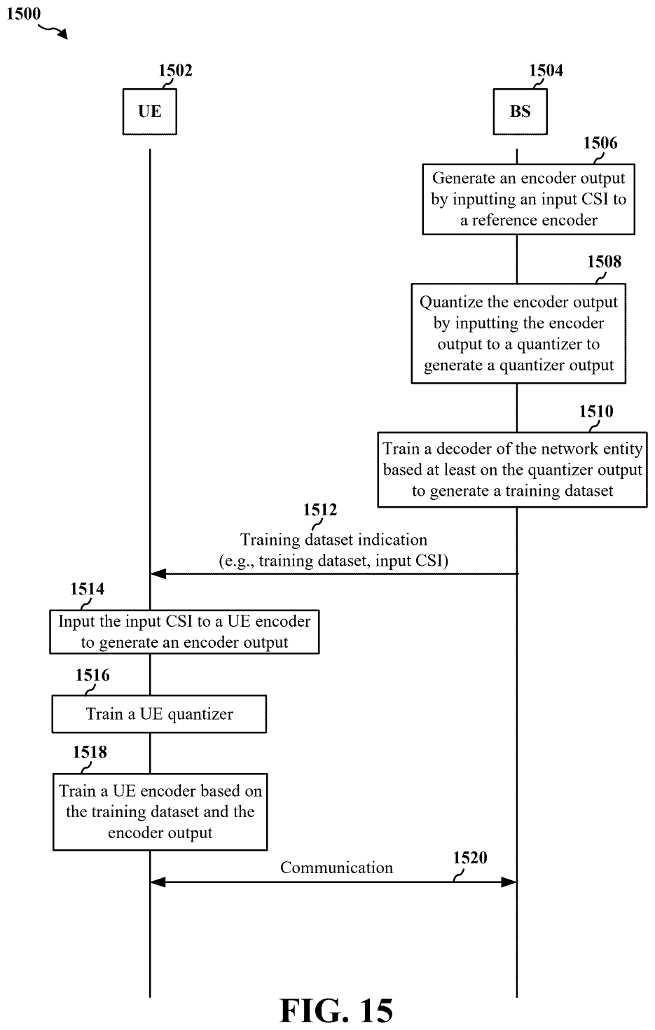

FIG. 15 is a call flow diagram 1500 of signaling between a UE 1502 and a base station 1504. The base station 1504 may be configured to provide at least one cell. The UE 1502 may be configured to communicate with the base station 1504. For example, in the context of FIG. 1, the base station 1504 may correspond to base station 102. Further, a UE 1502 may correspond to at least UE 104. In another example, in the context of FIG. 3, the base station 1504 may correspond to base station 310 and the UE 1502 may correspond to UE 350.

At 1506, the base station 1504 may generate an encoder output. The base station may generate the encoder output by inputting an input CSI (e.g., Vin) to a reference encoder. The base station generating the encoder output may be based on any of the aspects described in connection with FIGS. 7A-14.

At 1508, the base station 1504 may quantize the encoder output. The base station may quantize the encoder output by inputting the encoder output to a quantizer to generate a quantizer output. In some aspects, to quantize the encoder output, the base station may divide the encoder output into a plurality of blocks. In some aspects, to quantize the encoder output, the base station may map a value of each block of the plurality of blocks to a quantize value based on a quantization codebook. In some aspects, the training dataset indication may comprise the quantization codebook. The base station quantizing the encoder output may be based on any of the aspects described in connection with FIGS. 9A-10.

At 1510, the base station 1504 may train a decoder of the base station. The base station may train the decoder of the base station based at least on the quantizer output to generate a training dataset. The base station training the decoder of the base station may be based on any of the aspects described in connection with FIGS. 9A-14.

At 1512, the base station 1504 may output a training dataset indication. The base station may output the training dataset indication to the UE 1502. The UE 1502 may receive the training dataset indication from the base station 1504. The training dataset indication may comprise the training dataset. The training dataset may comprise at least the input CSI. In some aspects, the training dataset indication may further comprise at least the encoder output, the quantizer output, or both. The training dataset indication may comprise a training dataset to train an encoder of the UE. The training dataset may be associated with data processed at the base station. The base station outputting the training dataset indication may be based on any of the aspects described in connection with FIGS. 9A-14.

At 1514, the UE 1502 may input the input CSI (e.g., Vin) to the encoder of the UE. The UE may input the input CSI to the encoder of the UE to generate an encoder output. The input CSI comprised within the training dataset. The UE inputting the input CSI (e.g., Vin) to the encoder of the UE may be based on any of the aspects described in connection with FIGS. 11A-14.

At 1516, the UE 1502 train a UE quantizer. The UE may train the UE quantizer based on the quantizer output of the network entity and the input CSI. The input CSI may be inputted into the encoder of the UE and the UE quantizer to generate a UE encoder output. In some aspects, a loss between the UE encoder output and the quantizer output may be minimized. The UE training the UE quantizer may be based on any of the aspects described in connection with FIG. 14.

At 1518, the UE 1502 may train the encoder of the UE. The UE may train the encoder of the UE base on the training dataset and the encoder output. In some aspects, the training dataset may comprise a quantizer output of the network entity. In some aspects, the training dataset may comprise an encoder output of the network entity. In some aspects, the training dataset may comprise an encoder output of the network entity and a quantization codebook. The UE training the encoder of the UE may be based on any of the aspects described in connection with FIGS. 11A-14.

In some aspects, to train the encoder of the UE, the UE may minimize a loss between the quantizer output of the training dataset and the encoder. In some aspects, a value of the encoder output may be mapped to the quantizer output if the loss between the quantizer output and the encoder output is less than a first threshold. In some aspects, the training dataset may comprise a quantizer output of the network entity. The UE minimize a loss between the quantizer output of the training dataset and the encoder may be based on any of the aspects described in connection with FIGS. 11A.

In some aspects, to train the encoder of the UE, the UE may train a decoder of the UE. The UE may train the decoder of the UE based at least on the training dataset. In some aspects, the training dataset comprises a quantizer output of the network entity. The UE may then minimize an end to end loss between the decoder trained by the UE and the training dataset. In some aspects, the decoder trained by the UE minimizes an end to end loss between the input CSI and a decoder output of the UE. The UE training the decoder of the UE based at least on the training dataset may be based on any of the aspects described in connection with FIG. 11B.

In some aspects, to train the encoder of the UE, the UE may receive a reference decoder. The UE may receive the reference decoder from the network entity. The UE may then minimize an end to end loss between the reference decoder and the training dataset. In some aspects, the encoder trained by the UE may minimize an end to end loss between the input CSI and a decoder output of the UE. In some aspects, the training dataset comprises a quantizer output of the network entity. The UE receiving the reference decoder may be based on any of the aspects described in connection with FIG. 12B.

In some aspects, to train the encoder of the UE, the UE may minimize a loss between the encoder output of the network entity and the encoder output of the UE. In some aspects, the training dataset may comprise an encoder output of the network entity. The UE minimizing the loss between the encoder output of the network entity and the encoder output of the UE may be based on any of the aspects described in connection with FIG. 12A.

In some aspects, to train the encoder of the UE, the UE may minimize an end to end loss based on a reference decoder provided by the network entity. Input layers of the reference decoder may mimic a quantization operation. The end to end loss may be between the input CSI and an output of the reference decoder. In some aspects, the training dataset may comprise an encoder output of the network entity. The UE training the encoder of the UE may be based on any of the aspects described in connection with FIG. 12B.

In some aspects, to train the encoder of the UE, the UE may generate a quantizer output. The UE may generate the quantizer output based on the encoder output of the network entity and the quantization codebook. In some aspects, the training dataset may comprise the encoder output of the network entity and the quantization codebook. The UE may then minimize a loss between the quantizer output and an output of the encoder of the UE. The input CSI may be inputted into the encoder of the UE to generate the output of the encoder of the UE. The UE generating the quantizer output may be based on any of the aspects described in connection with FIG. 14.

In some aspects, to train the encoder of the UE, the UE may minimize an end to end loss. The UE may minimize the end to end loss based on a decoder trained by the UE based on the encoder output of the network entity and the input CSI or a reference decoder of the network entity. In some aspects, the training dataset may comprise the encoder output of the network entity and the quantization codebook. The UE training the encoder of the UE may be based on any of the aspects described in connection with FIGS. 11A-14.

In some aspects, to train the encoder of the UE, the UE may train the quantizer codebook. The UE may train the quantizer codebook based on the encoder output of the network entity and the input CSI. The encoder of the UE and the trained quantizer codebook may generate a quantized UE output. A loss between the encoder output of the network entity and the quantized UE output may be minimized. The UE training the quantizer codebook may be based on any of the aspects described in connection with FIG. 14.

At 1520, the UE 1502 and the base station 1504 may communicate with each other. The UE 1502 may communicate with the base station 1504 utilizing the trained encoder of the UE 1502. The base station 1504 may communicate with the base station 1504 utilizing the trained decoder of the base station 1504.

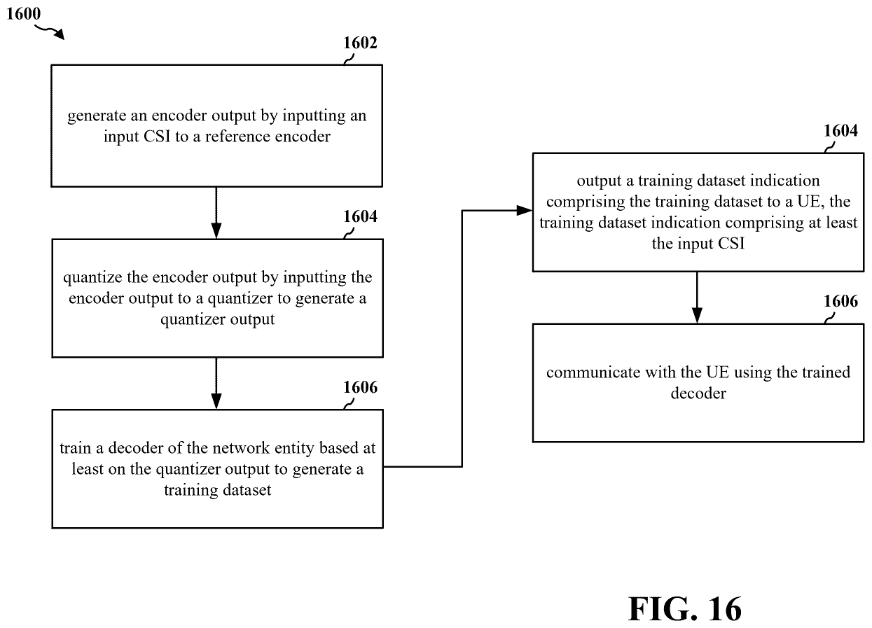

FIG. 16 is a flowchart 1600 of a method of wireless communication. The method may be performed by a base station (e.g., the base station 102; the network entity 1802. One or more of the illustrated operations may be omitted, transposed, or contemporaneous. The method may provide a training dataset to a UE.

At 1602, the network entity may generate an encoder output. For example, 1602 may be performed by train component 199 of network entity 1802. The network entity may generate the encoder output by inputting an input CSI to a reference encoder, as shown in connection with FIGS. 7A-14.

At 1604, the network entity may quantize the encoder output. For example, 1604 may be performed by train component 199 of network entity 1802. The network entity may quantize the encoder output by inputting the encoder output to a quantizer to generate a quantizer output, as shown in connection with FIGS. 9A-14.

At 1606, the network entity may train a decoder of the network entity. For example, 1606 may be performed by train component 199 of network entity 1802. The network entity may train the decoder of the network entity based at least on the quantizer output to generate a training dataset, as shown in connection with FIGS. 9A-14.

At 1608, the network entity may output a training dataset indication. For example, 1608 may be performed by train component 199 of network entity 1802. The network entity may output the training dataset indication to a UE, as shown in connection with FIGS. 9A-14. The training dataset indication may comprise the training dataset. The training dataset may comprise at least the input CSI. In some aspects, the training dataset indication may further comprise at least the encoder output, the quantizer output, or both.

At 1610, the network entity may communicate with the UE. For example, 1610 may be performed by train component 199 of network entity 1802. The network entity may communicate with the UE using the trained decoder.

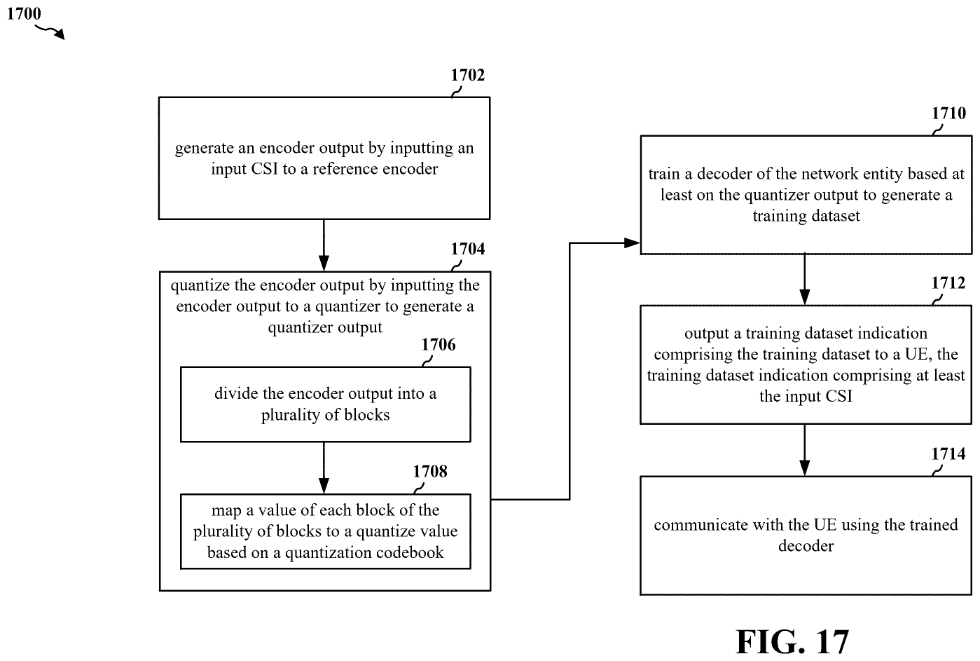

FIG. 17 is a flowchart 1700 of a method of wireless communication. The method may be performed by a base station (e.g., the base station 102; the network entity 1802.

One or more of the illustrated operations may be omitted, transposed, or contemporaneous. The method may provide a training dataset to a UE.

At 1702, the network entity may generate an encoder output. For example, 1702 may be performed by train component 199 of network entity 1802. The network entity may generate the encoder output by inputting an input CSI to a reference encoder, as shown in connection with FIGS. 7A-14.

At 1704, the network entity may quantize the encoder output. For example, 1604 may be performed by train component 199 of network entity 1802. The network entity may quantize the encoder output by inputting the encoder output to a quantizer to generate a quantizer output, as shown in connection with FIGS. 9A-14.

In some aspects, at 1706, to quantize the encoder output, the network entity may divide the encoder output. For example, 1706 may be performed by train component 199 of network entity 1802. The network entity may divide the encoder output into a plurality of blocks, as shown in connection with FIGS. 9A-10.

In some aspects, at 1708, to quantize the encoder output, the network entity may map a value of each block of the plurality of blocks to a quantize value based on a quantization codebook, as shown in connection with FIGS. 9A-10. For example, 1708 may be performed by train component 199 of network entity 1802. In some aspects, the training dataset indication may comprise the quantization codebook.

At 1710, the network entity may train a decoder of the network entity. For example, 1710 may be performed by train component 199 of network entity 1802. The network entity may train the decoder of the network entity based at least on the quantizer output to generate a training dataset, as shown in connection with FIGS. 9A-14.

At 1712, the network entity may output a training dataset indication. For example, 1712 may be performed by train component 199 of network entity 1802. The network entity may output the training dataset indication to a UE, as shown in connection with FIGS. 9A-14. The training dataset indication may comprise the training dataset. The training dataset may comprise at least the input CSI. In some aspects, the training dataset indication may further comprise at least the encoder output, the quantizer output, or both.

At 1714, the network entity may communicate with the UE. For example, 1714 may be performed by train component 199 of network entity 1802. The network entity may communicate with the UE using the trained decoder.

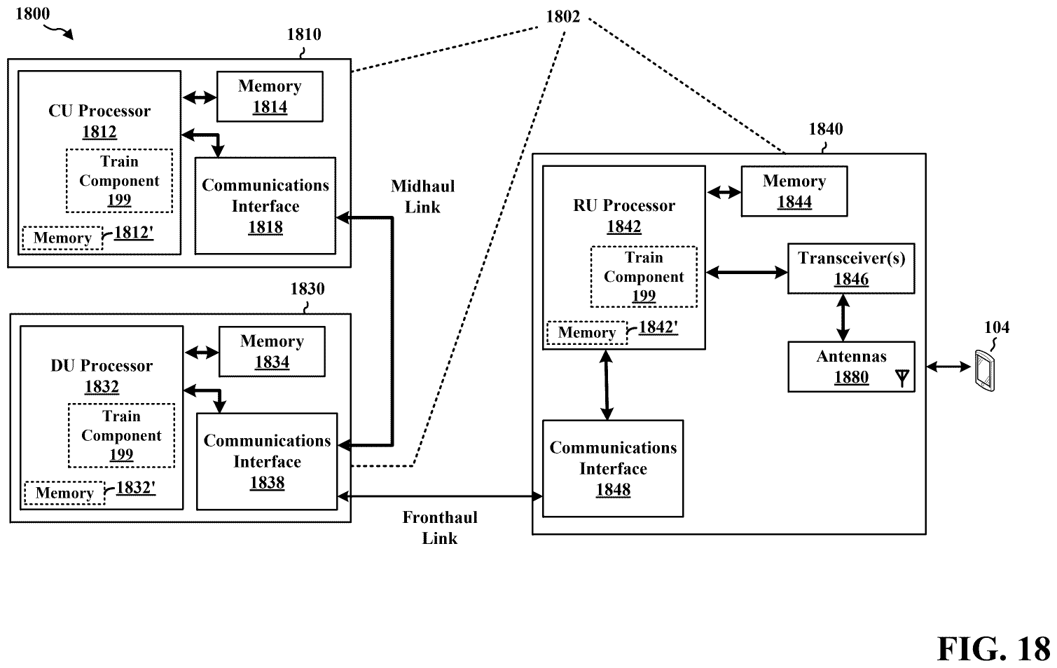

FIG. 18 is a diagram 1800 illustrating an example of a hardware implementation for a network entity 1802. The network entity 1802 may be a BS, a component of a BS, or may implement BS functionality. The network entity 1802 may include at least one of a CU 1810, a DU 1830, or an RU 1840. For example, depending on the layer functionality handled by the component 199, the network entity 1802 may include the CU 1810; both the CU 1810 and the DU 1830; each of the CU 1810, the DU 1830, and the RU 1840; the DU 1830; both the DU 1830 and the RU 1840; or the RU 1840. The CU 1810 may include a CU processor 1812. The CU processor 1812 may include on-chip memory 1812′. In some aspects, the CU 1810 may further include additional memory modules 1814 and a communications interface 1818. The CU 1810 communicates with the DU 1830 through a midhaul link, such as an FI interface. The DU 1830 may include a DU processor 1832. The DU processor 1832 may include on-chip memory 1832′. In some aspects, the DU 1830 may further include additional memory modules 1834 and a communications interface 1838. The DU 1830 communicates with the RU 1840 through a fronthaul link. The RU 1840 may include an RU processor 1842. The RU processor 1842 may include on-chip memory 1842′. In some aspects, the RU 1840 may further include additional memory modules 1844, one or more transceivers 1846, antennas 1880, and a communications interface 1848. The RU 1840 communicates with the UE 104. The on-chip memory 1812′, 1832′, 1842′ and the additional memory modules 1814, 1834, 1844 may each be considered a computer-readable medium/memory. Each computer-readable medium/memory may be non-transitory. Each of the processors 1812, 1832, 1842 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 is configured to generate an encoder output by inputting an input CSI to a reference encoder; quantize the encoder output by inputting the encoder output to a quantizer to generate a quantizer output; train a decoder of the network entity based at least on the quantizer output to generate a training dataset; output a training dataset indication comprising the training dataset to a UE, the training dataset indication comprising at least the input CSI; and communicate with the UE using the trained decoder. The component 199 may be within one or more processors of one or more of the CU 1810, DU 1830, and the RU 1840. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1802 may include a variety of components configured for various functions. In one configuration, the network entity 1802 includes means for generating an encoder output by inputting an input CSI to a reference encoder. The network entity includes means for quantizing the encoder output by inputting the encoder output to a quantizer to generate a quantizer output. The network entity includes means for training a decoder of the network entity based at least on the quantizer output to generate a training dataset. The network entity includes means for outputting a training dataset indication comprising the training dataset to a UE. The training dataset indication comprising at least the input CSI. The network entity includes means for communicating with the UE using the trained decoder. The network entity further includes means for dividing the encoder output into a plurality of blocks. The network entity further includes means for mapping a value of each block of the plurality of blocks to a quantize value based on a quantization codebook. The means may be the component 199 of the network entity 1802 configured to perform the functions recited by the means. As described supra, the network entity 1802 may include the TX processor 316, the RX processor 370, and the controller/processor 375. As such, in one configuration, the means may be the TX processor 316, the RX processor 370, and/or the controller/processor 375 configured to perform the functions recited by the means.

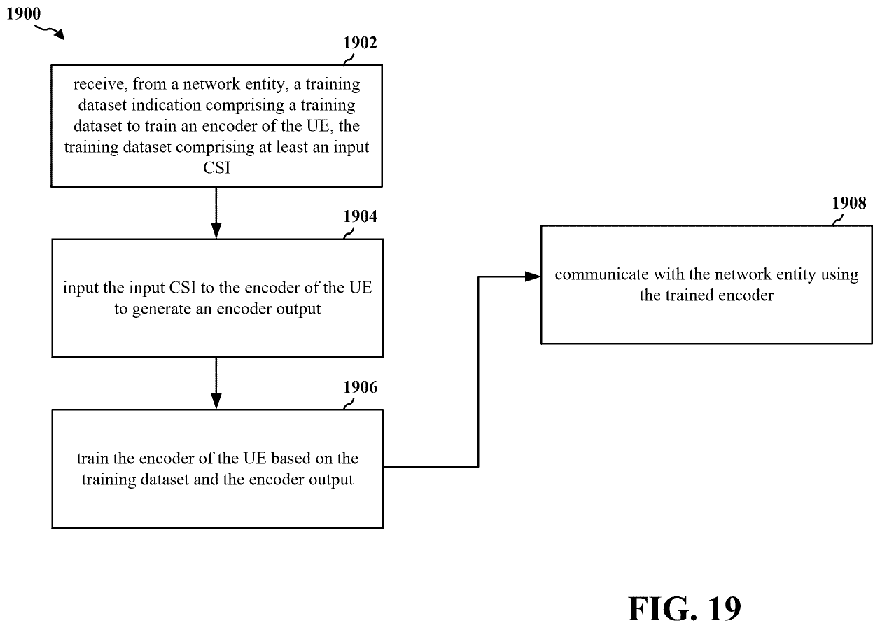

FIG. 19 is a flowchart 1900 of a method of wireless communication. The method may be performed by a UE (e.g., the UE 104; the apparatus 2104). One or more of the illustrated operations may be omitted, transposed, or contemporaneous. The method may allow a UE to train a UE encoder based on a training dataset provided by a network entity.

At 1902, the UE may receive a training dataset indication. For example, 1902 may be performed by train component 198 of apparatus 2104. The UE may receive the training dataset indication from a network entity, as shown in connection with FIGS. 9A-14. The training dataset indication may comprise a training dataset to train an encoder of the UE. The training dataset may comprise at least an input CSI.

At 1904, the UE may input the input CSI to the encoder of the UE. For example, 1904 may be performed by train component 198 of apparatus 2104. The UE may input the input CSI to the encoder of the UE to generate an encoder output, as shown in connection with FIGS. 11A-14.

At 1906, the UE may train the encoder of the UE. For example, 1906 may be performed by train component 198 of apparatus 2104. The UE may train the encoder of the UE base on the training dataset and the encoder output, as shown in connection with FIGS. 11A-14. In some aspects, the training dataset may comprise a quantizer output of the network entity. In some aspects, the training dataset may comprise an encoder output of the network entity. In some aspects, the training dataset may comprise an encoder output of the network entity and a quantization codebook.

At 1908, the UE may communicate with the network entity. For example, 1908 may be performed by train component 198 of apparatus 2104. The UE may communicate with the network entity using the trained encoder.

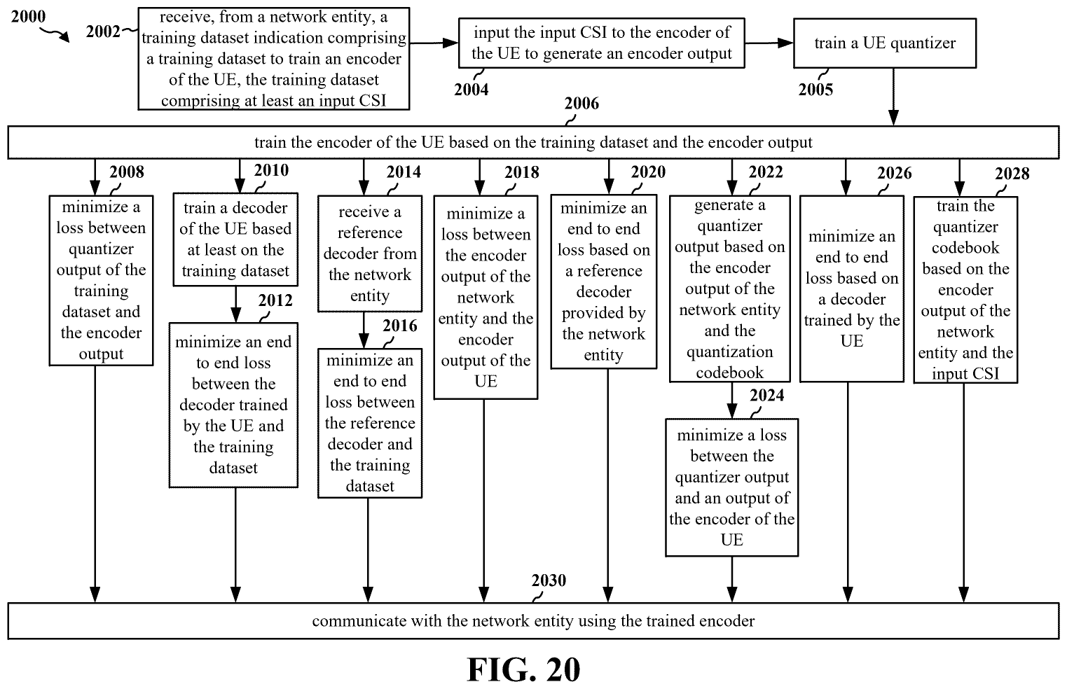

FIG. 20 is a flowchart 2000 of a method of wireless communication. The method may be performed by a UE (e.g., the UE 104; the apparatus 2104). One or more of the illustrated operations may be omitted, transposed, or contemporaneous. The method may allow a UE to train a UE encoder based on a training dataset provided by a network entity.

At 2002, the UE may receive a training dataset indication. For example, 2002 may be performed by train component 198 of apparatus 2104. The UE may receive the training dataset indication from a network entity, as shown in connection with FIGS. 9A-14. The training dataset indication may comprise a training dataset to train an encoder of the UE. The training dataset may comprise at least an input CSI.

At 2004, the UE may input the input CSI to the encoder of the UE. For example, 2004 may be performed by train component 198 of apparatus 2104. The UE may input the input CSI to the encoder of the UE to generate an encoder output, as shown in connection with FIGS. 11A-14.

At 2005, the UE may train a UE quantizer. For example, 2005 may be performed by train component 198 of apparatus 2104. The UE may train the UE quantizer based on the quantizer output of the network entity and the input CSI, as shown in connection with FIG. 14. The input CSI may be inputted into the encoder of the UE and the UE quantizer to generate a UE encoder output. In some aspects, a loss between the UE encoder output and the quantizer output may be minimized.

At 2006, the UE may train the encoder of the UE. For example, 2006 may be performed by train component 198 of apparatus 2104. The UE may train the encoder of the UE base on the training dataset and the encoder output, as shown in connection with FIGS. 11A-14. In some aspects, the training dataset may comprise a quantizer output of the network entity. In some aspects, the training dataset may comprise an encoder output of the network entity. In some aspects, the training dataset may comprise an encoder output of the network entity and a quantization codebook.

At 2008, to train the encoder of the UE, the UE may minimize a loss between the quantizer output of the training dataset and the encoder, as shown in connection with FIG. 11A. For example, 2008 may be performed by train component 198 of apparatus 2104. In some aspects, a value of the encoder output may be mapped to the quantizer output if the loss between the quantizer output and the encoder output is less than a first threshold. In some aspects, the training dataset may comprise a quantizer output of the network entity.

At 2010, to train the encoder of the UE, the UE may train a decoder of the UE. For example, 2010 may be performed by train component 198 of apparatus 2104. The UE may train the decoder of the UE based at least on the training dataset, as shown in connection with FIG. 11B. In some aspects, the training dataset comprises a quantizer output of the network entity.

At 2012, to train the encoder of the UE, the UE may minimize an end to end loss between the decoder trained by the UE and the training dataset, as shown in connection with FIGS. 11A-14. For example, 2012 may be performed by train component 198 of apparatus 2104. In some aspects, the decoder trained by the UE minimizes an end to end loss between the input CSI and a decoder output of the UE. In some aspects, the training dataset comprises a quantizer output of the network entity.

At 2014, to train the encoder of the UE, the UE may receive a reference decoder. For example, 2014 may be performed by train component 198 of apparatus 2104. The UE may receive the reference decoder from the network entity, as shown in connection with FIG. 12B.

At 2016, to train the encoder of the UE, the UE may minimize an end to end loss between the reference decoder and the training dataset, as shown in connection with FIG. 12B. For example, 2016 may be performed by train component 198 of apparatus 2104. In some aspects, the encoder trained by the UE may minimize an end to end loss between the input CSI and a decoder output of the UE. In some aspects, the training dataset comprises a quantizer output of the network entity.

At 2018, to train the encoder of the UE, the UE may minimize a loss between the encoder output of the network entity and the encoder output of the UE, as shown in connection with any of FIGS. 11A-14. For example, 2018 may be performed by train component 198 of apparatus 2104. In some aspects, the training dataset may comprise an encoder output of the network entity.

At 2020, to train the encoder of the UE, the UE may minimize an end to end loss based on a reference decoder provided by the network entity, as shown in connection with FIG. 12B. For example, 2020 may be performed by train component 198 of apparatus 2104. Input layers of the reference decoder may mimic a quantization operation. The end to end loss may be between the input CSI and an output of the reference decoder. In some aspects, the training dataset may comprise an encoder output of the network entity.

At 2022, to train the encoder of the UE, the UE may generate a quantizer output. For example, 2022 may be performed by train component 198 of apparatus 2104. The UE may generate the quantizer output based on the encoder output of the network entity and the quantization codebook, as shown in connection with FIG. 14. In some aspects, the training dataset may comprise the encoder output of the network entity and the quantization codebook.

At 2024, to train the encoder of the UE, the UE may minimize a loss between the quantizer output and an output of the encoder of the UE, as shown in connection with any of FIGS. 11A-14. For example, 2024 may be performed by train component 198 of apparatus 2104. The input CSI may be inputted into the encoder of the UE to generate the output of the encoder of the UE.

At 2026, to train the encoder of the UE, the UE may minimize an end to end loss. For example, 2026 may be performed by train component 198 of apparatus 2104. The UE may minimize the end to end loss based on a decoder trained by the UE based on the encoder output of the network entity and the input CSI or a reference decoder of the network entity, as shown in connection with any of FIGS. 11A-14. In some aspects, the training dataset may comprise the encoder output of the network entity and the quantization codebook.

At 2028, to train the encoder of the UE, the UE may train the quantizer codebook. For example, 2028 may be performed by train component 198 of apparatus 2104. The UE may train the quantizer codebook based on the encoder output of the network entity and the input CSI, as shown in connection with FIG. 14. The encoder of the UE and the trained quantizer codebook may generate a quantized UE output. A loss between the encoder output of the network entity and the quantized UE output may be minimized.

At 2030, the UE may communicate with the network entity. For example, 2030 may be performed by train component 198 of apparatus 2104. The UE may communicate with the network entity using the trained encoder.

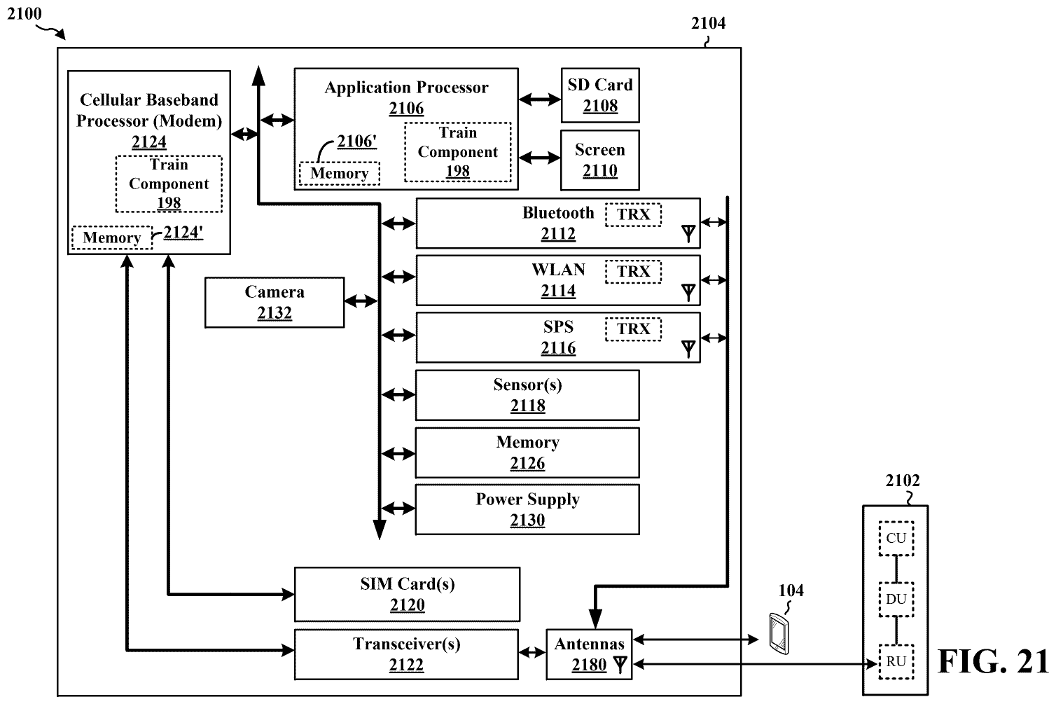

FIG. 21 is a diagram 2100 illustrating an example of a hardware implementation for an apparatus 2104. The apparatus 2104 may be a UE, a component of a UE, or may implement UE functionality. In some aspects, the apparatus2104 may include a cellular baseband processor 2124 (also referred to as a modem) coupled to one or more transceivers 2122 (e.g., cellular RF transceiver). The cellular baseband processor 2124 may include on-chip memory 2124′. In some aspects, the apparatus 2104 may further include one or more subscriber identity modules (SIM) cards 2120 and an application processor 2106 coupled to a secure digital (SD) card 2108 and a screen 2110. The application processor 2106 may include on-chip memory 2106′. In some aspects, the apparatus 2104 may further include a Bluetooth module 2112, a WLAN module 2114, an SPS module 2116 (e.g., GNSS module), one or more sensor modules 2118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 2126, a power supply 2130, and/or a camera 2132. The Bluetooth module 2112, the WLAN module 2114, and the SPS module 2116 may include an on-chip transceiver (TRX) (or in some cases, just a receiver (RX)). The Bluetooth module 2112, the WLAN module 2114, and the SPS module 2116 may include their own dedicated antennas and/or utilize the antennas 2180 for communication. The cellular baseband processor 2124 communicates through the transceiver(s) 2122 via one or more antennas 2180 with the UE 104 and/or with an RU associated with a network entity 2102. The cellular baseband processor 2124 and the application processor 2106 may each include a computer-readable medium/memory 2124′, 2106′, respectively. The additional memory modules 2126 may also be considered a computer-readable medium/memory. Each computer- readable medium/memory 2124′, 2106′, 2126 may be non-transitory. The cellular baseband processor 2124 and the application processor 2106 are each responsible for general processing, including the execution of software stored on the computer-readable medium/memory. The software, when executed by the cellular baseband processor 2124/application processor 2106, causes the cellular baseband processor 2124/application processor 2106 to perform the various functions described supra. The computer-readable medium/memory may also be used for storing data that is manipulated by the cellular baseband processor 2124/application processor 2106 when executing software. The cellular baseband processor 2124/application processor 2106 may be a component of the UE 350 and may include the memory 360 and/or at least one of the TX processor 368, the RX processor 356, and the controller/processor 359. In one configuration, the apparatus 2104 may be a processor chip (modem and/or application) and include just the cellular baseband processor 2124 and/or the application processor 2106, and in another configuration, the apparatus 2104 may be the entire UE (e.g., sec 350 of FIG. 3) and include the additional modules of the apparatus 2104.

As discussed supra, the component 198 is configured to receive, from a network entity, a training dataset indication comprising a training dataset to train an encoder of the UE, the training dataset comprising at least an input CSI; input the input CSI to the encoder of the UE to generate an encoder output; train the encoder of the UE based on the training dataset and the encoder output; and communicate with the network entity using the trained encoder. The component 198 may be within the cellular baseband processor 2124, the application processor 2106, or both the cellular baseband processor 2124 and the application processor 2106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 2104 may include a variety of components configured for various functions. In one configuration, the apparatus 2104, and in particular the cellular baseband processor 2124 and/or the application processor 2106, includes means for receiving, from a network entity, a training dataset indication comprising a training dataset to train an encoder of the UE. The training dataset comprising at least an input CSI. The apparatus includes means for inputting the input CSI to the encoder of the UE to generate an encoder output. The apparatus includes means for training the encoder of the UE based on the training dataset and the encoder output. The apparatus includes means for communicating with the network entity using the trained encoder. The apparatus further includes means for minimizing a loss between the quantizer output of the training dataset and the encoder output. The apparatus further includes means for training a decoder of the UE based at least on the training dataset. The apparatus further includes means for minimizing an end to end loss between the decoder trained by the UE and the training dataset. The apparatus further includes means for receiving a reference decoder from the network entity. The apparatus further includes means for minimizing an end to end loss between the reference decoder and the training dataset. The apparatus further includes means for minimizing a loss between the encoder output of the network entity and the encoder output of the UE. The apparatus further includes means for minimizing an end to end loss based on a reference decoder provided by the network entity. Input layers of the reference decoder mimic a quantization operation, wherein the end to end loss is between the input CSI and an output of the reference decoder. The apparatus further includes means for generating a quantizer output based on the encoder output of the network entity and the quantization codebook. The apparatus further includes means for minimizing a loss between the quantizer output and an output of the encoder of the UE. The input CSI is inputted into the encoder of the UE to generate the output of the encoder of the UE. The apparatus further includes means for minimizing an end to end loss based on a decoder trained by the UE based on the encoder output of the network entity and the input CSI or a reference decoder of the network entity. The apparatus further includes means for training a UE quantizer based on the quantizer output of the network entity and the input CSI. The input CSI is inputted into the encoder of the UE and the UE quantizer to generate a UE encoder output. The apparatus further includes means for training the quantizer codebook based on the encoder output of the network entity and the input CSI. The encoder of the UE and the trained quantizer codebook generate a quantized UE output. A loss between the encoder output of the network entity and the quantized UE output is minimized. The means may be the component 198 of the apparatus 2104 configured to perform the functions recited by the means. As described supra, the apparatus 2104 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a network entity, comprising generating an encoder output by inputting an input CSI to a reference encoder; quantizing the encoder output by inputting the encoder output to a quantizer to generate a quantizer output; training a decoder of the network entity based at least on the quantizer output to generate a training dataset; outputting a training dataset indication comprising the training dataset to a UE, the training dataset indication comprising at least the input CSI; and communicating with the UE using the trained decoder.

Aspect 2 is the method of aspect 1, further including dividing the encoder output into a plurality of blocks; and mapping a value of each block of the plurality of blocks to a quantize value based on a quantization codebook.

Aspect 3 is the method of any of aspects 1 and 2, further includes that the training dataset indication comprises the quantization codebook.

Aspect 4 is the method of any of aspects 1-3, further includes that the training dataset indication further comprises at least the encoder output, the quantizer output, or both.

Aspect 5 is an apparatus for wireless communication at a network entity including at least one processor coupled to a memory and at least one transceiver, the at least one processor configured to implement any of Aspects 1-4.

Aspect 6 is an apparatus for wireless communication at a network entity including means for implementing any of Aspects 1-4.

Aspect 7 is a computer-readable medium storing computer executable code, where the code when executed by a processor causes the processor to implement any of Aspects 1-4.

Aspect 8 is a method of wireless communication at a UE, comprising receiving, from a network entity, a training dataset indication comprising a training dataset to train an encoder of the UE, the training dataset comprising at least an input CSI; inputting the CSI to the encoder of the UE to generate an encoder output; training the encoder of the UE based on the training dataset and the encoder output; and communicating with the network entity using the trained encoder.

Aspect 9 is the method of aspect 8, further includes that the training dataset comprises a quantizer output of the network entity.

Aspect 10 is the method of any of aspects 8 and 9, further including minimizing a loss between the quantizer output of the training dataset and the encoder output.

Aspect 11 is the method of any of aspects 8-10, further includes that a value of the encoder output is mapped to the quantizer output if the loss between the quantizer output and the encoder output is less than a first threshold.

Aspect 12 is the method of any of aspects 8-11, further including training a decoder of the UE based at least on the training dataset; and minimizing an end to end loss between the decoder trained by the UE and the training dataset.

Aspect 13 is the method of any of aspects 8-12, further includes that the decoder trained by the UE minimizes an end to end loss between the input CSI and a decoder output of the UE.

Aspect 14 is the method of any of aspects 8-13, further including receiving a reference decoder from the network entity; and minimizing an end to end loss between the reference decoder and the training dataset.

Aspect 15 is the method of any of aspects 8-14, further includes that the encoder trained by the UE minimizes an end to end loss between the input CSI and a decoder output of the UE.

Aspect 16 is the method of any of aspects 8-15, further includes that the training dataset comprises an encoder output of the network entity.

Aspect 17 is the method of any of aspects 8-16, further including minimizing a loss between the encoder output of the network entity and the encoder output of the UE.

Aspect 18 is the method of any of aspects 8-17, further including minimizing an end to end loss based on a reference decoder provided by the network entity, wherein input layers of the reference decoder mimic a quantization operation, wherein the end to end loss is between the input CSI and an output of the reference decoder.

Aspect 19 is the method of any of aspects 8-18, further includes that the training dataset comprise an encoder output of the network entity and a quantization codebook.

Aspect 20 is the method of any of aspects 8-19, further including generating a quantizer output based on the encoder output of the network entity and the quantization codebook; and minimizing a loss between the quantizer output and an output of the encoder of the UE, wherein the input CSI is inputted into the encoder of the UE to generate the output of the encoder of the UE.

Aspect 21 is the method of any of aspects 8-20, further including minimizing an end to end loss based on a decoder trained by the UE based on the encoder output of the network entity and the input CSI or a reference decoder of the network entity.

Aspect 22 is the method of any of aspects 8-21, further including training a UE quantizer based on the quantizer output of the network entity and the input CSI, wherein the input CSI is inputted into the encoder of the UE and the UE quantizer to generate a UE encoder output.

Aspect 23 is the method of any of aspects 8-22, further includes that a loss between the UE encoder output and the quantizer output is minimized.

Aspect 24 is the method of any of aspects 8-23, further including training the quantizer codebook based on the encoder output of the network entity and the input CSI, wherein the encoder of the UE and the trained quantizer codebook generate a quantized UE output, wherein a loss between the encoder output of the network entity and the quantized UE output is minimized.

Aspect 25 is an apparatus for wireless communication at a UE including at least one processor coupled to a memory and at least one transceiver, the at least one processor configured to implement any of Aspects 8-24.

Aspect 26 is an apparatus for wireless communication at a UE including means for implementing any of Aspects 8-24.

Aspect 27 is a computer-readable medium storing computer executable code, where the code when executed by a processor causes the processor to implement any of Aspects 8-24.

1. An apparatus for wireless communication at a network entity, comprising:
a memory; and
at least one processor coupled to the memory and, based at least in part on information stored in the memory, the at least one processor is configured to:
generate an encoder output by inputting an input channel state information (CSI) to a reference encoder;
quantize the encoder output by inputting the encoder output to a quantizer to generate a quantizer output;
train a decoder of the network entity based at least on the quantizer output to generate a training dataset;
output a training dataset indication comprising the training dataset to a user equipment (UE), the training dataset indication comprising at least the input CSI; and
communicate with the UE using the trained decoder.

2. The apparatus of claim 1, further comprising a transceiver coupled to the at least one processor.

3. The apparatus of claim 1, wherein to quantize the encoder output the at least one processor is configured to:
divide the encoder output into a plurality of blocks; and
map a value of each block of the plurality of blocks to a quantize value based on a quantization codebook.

4. The apparatus of claim 3, wherein the training dataset indication comprises the quantization codebook.

5. The apparatus of claim 1, wherein the training dataset indication further comprises at least the encoder output, the quantizer output, or both.

6-7. (canceled)

8. An apparatus for wireless communication at a user equipment (UE), comprising:
a memory; and
at least one processor coupled to the memory and, based at least in part on information stored in the memory, the at least one processor is configured to:
receive, from a network entity, a training dataset indication comprising a training dataset to train an encoder of the UE, the training dataset comprising at least an input channel state information (CSI);
input the CSI to the encoder of the UE to generate an encoder output;
train the encoder of the UE based on the training dataset and the encoder output and
communicate with the network entity using the trained encoder.

9. The apparatus of claim 8, further comprising a transceiver coupled to the at least one processor.

10. The apparatus of claim 8, wherein the training dataset comprises a quantizer output of the network entity.

11. The apparatus of claim 10, wherein to train the encoder of the UE the at least one processor is configured to:
minimize a loss between the quantizer output of the training dataset and the encoder output

12. The apparatus of claim 11, wherein a value of the encoder output is mapped to the quantizer output if the loss between the quantizer output and the encoder output is less than a first threshold.

13. The apparatus of claim 10, wherein to train the encoder of the UE the at least one processor is configured to:
train a decoder of the UE based at least on the training dataset; and
minimize an end to end loss between the decoder trained by the UE and the training dataset

14. The apparatus of claim 13, wherein the decoder trained by the UE minimizes an end to end loss between the input CSI and a decoder output of the UE.

15. The apparatus of claim 10, wherein to train the encoder of the UE the at least one processor is configured to:
receive a reference decoder from the network entity; and
minimize an end to end loss between the reference decoder and the training dataset.

16. The apparatus of claim 15, wherein the encoder trained by the UE minimizes an end to end loss between the input CSI and a decoder output of the UE.

17. The apparatus of claim 8, wherein the training dataset comprises an encoder output of the network entity.

18. The apparatus of claim 17, wherein to train the encoder of the UE the at least one processor is configured to:
minimize a loss between the encoder output of the network entity and the encoder output of the UE.

19. The apparatus of claim 17, wherein to train the encoder of the UE the at least one processor is configured to:
minimize an end to end loss based on a reference decoder provided by the network entity, wherein input layers of the reference decoder mimic a quantization operation, wherein the end to end loss is between the input CSI and an output of the reference decoder.

20. The apparatus of claim 8, wherein the training dataset comprise an encoder output of the network entity and a quantization codebook.

21-22. (canceled)

23. The apparatus of claim 10, wherein the at least one processor is configured to:
train a UE quantizer based on the quantizer output of the network entity and the input CSI, wherein the input CSI is inputted into the encoder of the UE and the UE quantizer to generate a UE encoder output.

24-25. (canceled)

26. A method of wireless communication at a user equipment (UE), comprising:
receiving, from a network entity, a training dataset indication comprising a training dataset to train an encoder of the UE, the training dataset comprising at least an input channel state information (CSI);
inputting the input CSI to the encoder of the UE to generate an encoder output;
training the encoder of the UE based on the training dataset and the encoder output; and
communicating with the network entity using the trained encoder.

27-30. (canceled)
